(19) United States
(12) Patent Application Publication
(10) Pub. No.: US 2003/0064350 A1
(43) Pub. Date: Apr. 3, 2003

(54) Beauty advisory system and method

(76) Inventors: Gilles Rubinstenn, Paris (FR); Daniela Giacchetti, Paris (FR); Francis Pruche, Senlis (FR)

Correspondence Address: FINNEGAN, HENDERSON, FARABOW, GARRETT & DUNNER, L.L.P., 1300 I Street, N.W., Washington, DC, 20005-3315, US

(21) Appl. No.: 10/024,496

(22) Filed: Dec. 21, 2001

Related U.S. Application Data
(60) Provisional application No. 60/325,559, filed on Oct. 1, 2001.

(51) Int. Cl. G09B 19/00

(52) U.S. Cl. 434/99

(57) ABSTRACT

Systems and methods consistent with the invention may provide beauty advice. Personal information about a subject may be obtained. The personal information may include at least demographic information about the subject. The demographic information may include a geographic location of the subject. Based on the demographic information, local information may be determined. Then, based on the personal information and the local information, at least one recommendation for use of at least one beauty product may be generated and presented.

### BACKGROUND OF THE INVENTION

1. Field of the Invention

The invention relates to methods, systems, and articles of manufacture for providing beauty advice. In one example, systems and methods consistent with the invention may recommend a beauty product to a subject based on personal information, such as a skin condition, of the subject and local information, such as weather information, for the geographic area location of the subject.

2. Description of Related Art

Although the invention, in its broadest sense, is not limited to beauty products, beauty products are mentioned herein for purposes of providing the reader with an idea of some of the exemplary principles of the invention. As used herein, the term “beauty product” generally refers to any product that may be used for affecting one or more external body conditions of a subject. Such products may include, but are not limited to, anti-aging compounds, elasticity enhancers, hair coloring products, moisturizers, tanners, anti-wrinkle agents, blushes, mascaras, eyeliners, lip liners, lipsticks, lip glosses, eyebrow liners, eye shadows, nail polishes, foundations, concealers, dental whitening products, cellulite reduction products, shampoos, conditioners, hair straightners and curlers, weight reduction products, and any other product that affects a subject's appearance. Moreover, as used herein, the term “beauty product” may include merchandise, beauty services, such as those performed in salons, spas, and other beauty facilities, and beauty actions such as therapies, exercises, etc.

Over the years, it has become increasingly difficult for a consumer to choose a beauty product. There has been an increase in both the number of beauty products and the number of brands for those products, thus making it difficult to choose the right beauty product.

Moreover, a consumer may want to select a beauty product based on several personal factors. In some cases, a consumer may become overwhelmed by the sheer number of choices and depend on professional advice provided by a beauty consultant in order to select an appropriate product. While beauty consultants are often very helpful in making product recommendations, a number of modern techniques for marketing and sales of beauty products are unable to provide for such a personal advisor. For example, discount stores, on-line purchase arrangements, telephone ordering, and mail-in product purchases often lack any significant communication exchange other than that absolutely necessary to consummate a product sale.

### SUMMARY OF A FEW ASPECTS OF THE INVENTION

In one aspect, systems and methods consistent with the invention may provide beauty advice. In this aspect, personal information about a subject may be obtained. The personal information may include at least demographic information about the subject. The demographic information may include a geographic location of the subject. Based on the demographic information, local information may be determined. Then, based on the personal information and/or the local information, at least one recommendation for use of at least one beauty product may be generated and presented.

In another aspect, a subject may submit a request for beauty advice. In still another aspect, a subject may purchase the at least one recommended beauty product. In yet another aspect, a plurality of categories, each category being defined by a personal characteristic, may be maintained and a recommendation may be generated based on local information and at least one of the categories.

As described hereafter, the invention is multifaceted. Thus, the preceding summary of a few aspects of the invention is exemplary only and is not to be interpreted as defining the invention.

### BRIEF DESCRIPTION OF THE DRAWINGS

FIG. 1 is an exemplary screen shot illustrating a web page that may be displayed to a subject when the subject requests beauty advice from a vendor web site, consistent with methods and systems of the present invention;

FIG. 2 illustrates a flowchart of an exemplary method for providing beauty advice consistent with an embodiment of the present invention;

FIG. 3 illustrates an example of questionnaire a vendor may use to obtain information about a subject, consistent with methods and systems of the present invention;

FIGS. 4-6 are exemplary screen shots of pages that may be displayed to a subject, consistent with methods and systems of the present invention;

FIG. 7 is block diagram of an exemplary system environment, in which the invention may be practiced;

FIG. 8 is an exemplary block diagram of a computer consistent with methods and systems of the present invention;

FIG. 9 is a flowchart illustrating exemplary steps of a collection process consistent with methods and systems of the present invention; and

FIG. 10 is a flowchart illustrating exemplary steps of an analysis process consistent with methods and systems of the present invention.

### DESCRIPTION OF EXEMPLARY EMBODIMENTS

In the foregoing description of exemplary embodiments, reference will be made to the accompanying drawings in which like numerals may represent the same or like elements.

Methods and systems consistent with the present invention may provide beauty advice. In one example, a vendor who sells beauty products may obtain and store personal information about a subject, such as age information and/or demographic information. Based on this information, the vendor optionally may select a variety of beauty products suitable for the subject and/or possibly cause beauty products to be delivered to the subject (e.g., cause beauty product samples to be sent to the subject for sampling and/or cause beauty products to be sent to the subject in response to a purchase order). When the subject wants to know which beauty product the subject should apply on a given day, the subject may use a computer to access a vendor web site and request beauty advice. The vendor web site may determine local information for the subject, such as weather information for the geographic area of the subject. Based on this local information as well as the subject's personal information, the web site may generate and present one or more beauty product recommendations to the subject. The recommended beauty product may include one of the products that was selected by the vendor.

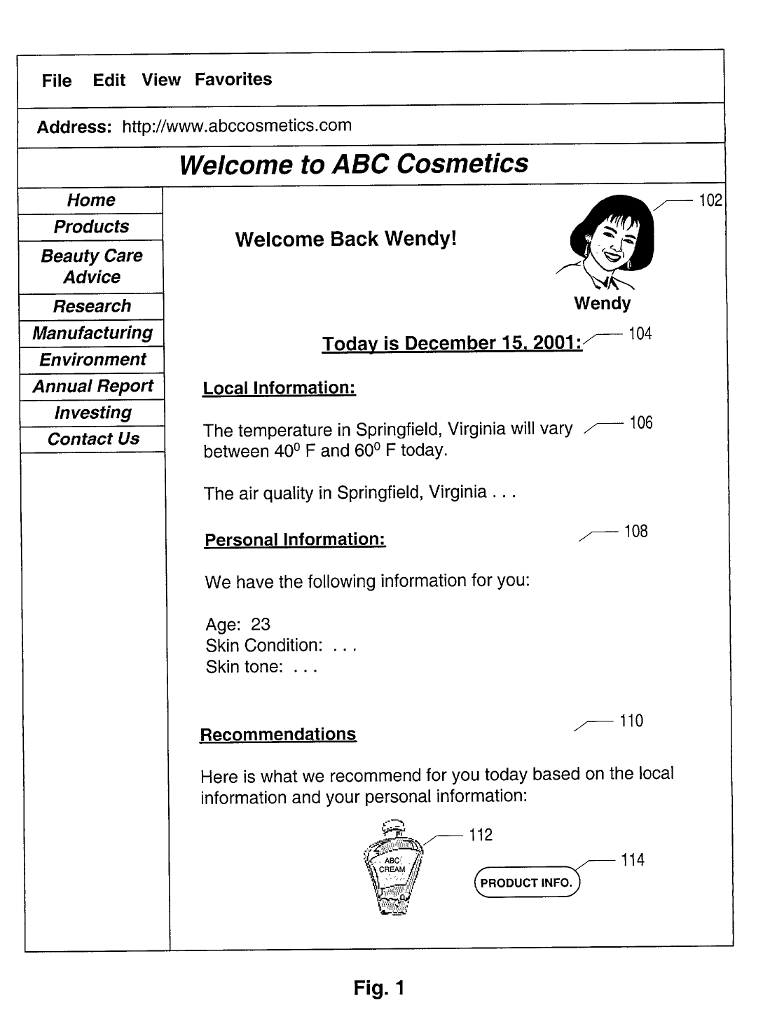

FIG. 1 is an exemplary screen shot illustrating a web page that may be displayed to a subject when the subject requests beauty advice from a vendor web site, consistent with methods and systems of the present invention. In this example, the web page may include an image 102 of the subject; date information 104, local information 106, personal information 108, and recommendations 110 for beauty product(s). The recommendations may include the name and/or image 112 of the beauty product(s). In addition, the web page may include a button 114 that the subject may select to obtain more information about the product, such as instructions for applying the product, recommended uses for the product, current sales promotions for the product, and an indication of how and/or where the product may be purchased, etc.

The preceding discussion is intended to provide an exemplary overview of the invention. Further details and other examples follow. However, it is to be understood that other alternative embodiments may be utilized and that structural and method changes may be made without departing from the scope of the present invention. The foregoing and following discussion are, therefore, not to be construed in a limiting sense.

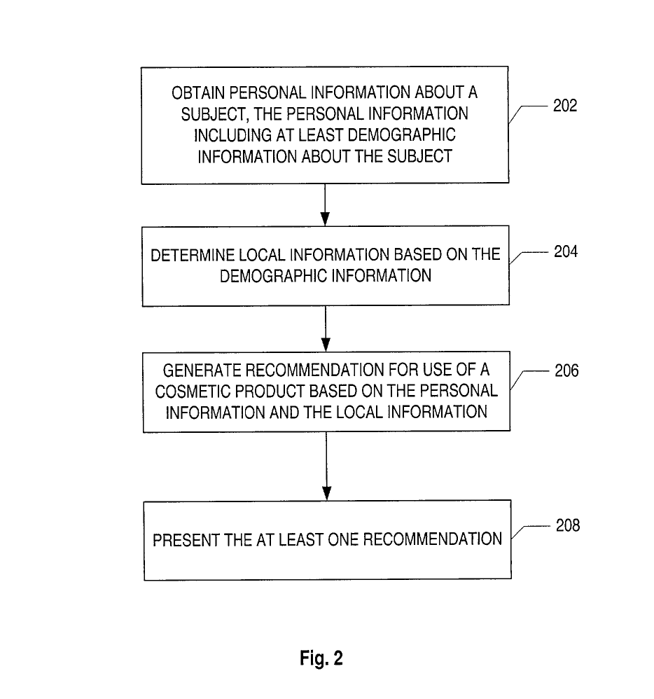

One embodiment of the invention may include a method of providing beauty advice. FIG. 2 illustrates an exemplary flow chart of such a method. The method may include obtaining personal information about a subject (step 202). Personal information may include demographic information, such as information about the geographic area location where the subject resides, works, and/or intends to travel. A geographic area location may include at least one of a street address, city, state, town, region, category of a location (e.g. tropical, desert, etc.), or location. The demographic information can reflect the geographic area location either by positively identifying a specific area location or by characterizing the area location, such as by identifying typical environment conditions at the area location. Personal information may also include an image, such as a picture or a multimedia file, of a subject; information about one or more of the subject's characteristics or attributes (physical, physiological, biological, and aesthetic), such as age, skin condition, skin tone, propensity to tan, hair color, and facial feature characteristics; lifestyle information, such as fashion preferences, clothing color preferences, cosmetic preferences, and eating habits; environmental information, such as sun exposure habits; nutritional information; medical history information; dietary supplement usage information; family history information, such as physical characteristics information about relatives of the subject; and other personal information about the subject. The image may be an actual or a simulated image. Simulated images may include wholly or partially generated computer images, images based on existing images, and images based on stored features of a subject. Physical characteristics information may also include one or more of color, tone, texture, elasticity, oiliness, and pH relating to at least one of the subject's hair and skin.

Examples of techniques relating to processing of images for use in simulating beauty products are disclosed in PCT Publication No. WO 01/77976, published Oct. 18, 2001, the disclosure of which is incorporated herein by reference. Software for such processing is also available from EZ-Face™ of Israel.

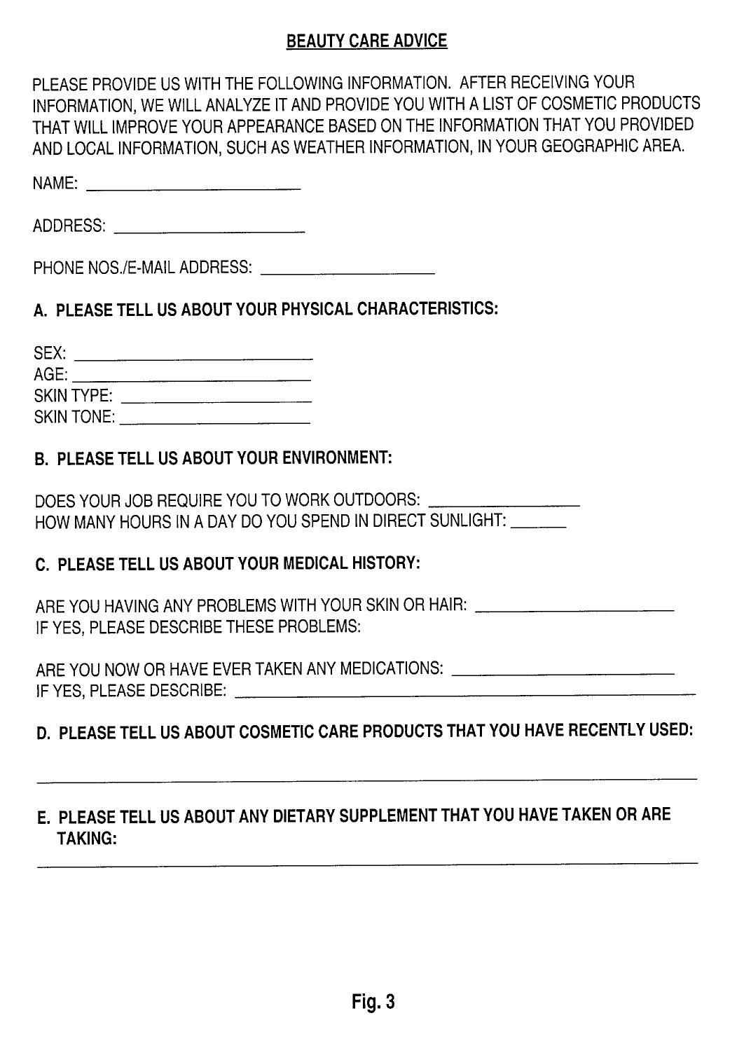

Personal information may be obtained in a variety of ways, including electronically and manually. For example, as explained in more detail below, a collection process may be used to electronically obtain personal information about a subject. The information may be obtained while the subject is located at their home or office. Alternatively, the information may be collected at a salon or other facility not controlled by the subject. The information may also be collected via physical mail and/or e-mail, for example, by receiving a subject's response to a questionnaire prompting a subject to provide personal information. An example of a first part of such a questionnaire is shown in FIG. 3. As shown, the questionnaire may include a series of questions that ask the subject to supply various items of information, such as physical characteristics information, demographic information, environmental information, medical history information, lifestyle, dietary supplement use information, family history information, and other personal information about the subject. The questionnaire may also ask the subject for an image and may include specifications for the image, such as lighting conditions and size.

Alternatively (or additionally), information about the subject may have been previously stored and the obtaining of step 202 of FIG. 2 may involve retrieving that stored information. For example, if the information was previously stored in a database, the information may be retrieved from the database.

The method may also include determining local information based on the demographic information (step 204). Local information may include weather information, cosmetic usage information of others, air quality data, temperature data, precipitation data, humidity data, wind data, ultra-violet radiation data, climate data, and/or ecological data in the geographic area location of the subject.

The local information may be determined in a variety of ways, including electronically and manually. Determining the local information may involve obtaining at least some of the local information from another party, such as a weather forecasting service. For example, the local information could be obtained from a web site and/or database maintained by another party. Alternatively (or additionally), the subject may be prompted to provide at least some of the local information. To obtain the local information, questionnaires may be sent via mail or e-mail to random individuals who live or work near the subject. In addition (or alternatively), the local information may be previously stored information and the determining step 204 may involve retrieving that stored information. The local information may also be determined using projection methods, such as analyzing the local information from the past to generate local information for the future.

The method may also include generating at least one recommendation for use of at least one beauty product based on at least one of the personal information and the local information (step 206). The recommendation may be generated using a variety of techniques. For example, artificial intelligence mechanisms may be employed to identify correlations between personal information of a subject, local information, and information about particular beauty products. The recommendation could be generated by selecting product information in a database based on the personal information and/or local information. The correlations may depend on research and/or experience of a vendor or of other parties. The recommendation may include beauty products that improve a subject's appearance, such as a recommendation to use a beauty product that adds color to the face of the subject.

When the product recommendation is based at least in part on the personal information, the recommended product may match one or more of the subject's personal preferences, such as color, product brand, product type, etc. and/or a personal trait of the subject.

For a product recommendation based at least in part on local information, the recommended product may be a product useful for dealing with certain forecasted weather conditions in the subject's locale. For example, if the local information includes information indicating that the UV index will be relatively high, the product recommendation might include a recommendation to use a relatively strong (high SPF) sunscreen. In another example, where the local information includes information indicating that the weather will include high winds, the product recommendation may include a recommendation to use a hair styling product, such as hair spray, hair gel, and/or mousse, as well as a recommendation to use a skin moisturizer.

Moreover, although not shown in FIG. 2, the method may also include receiving variable preference information. Variable preference information may include an identification of clothing that a subject intends to wear. The identification of clothing may include the type and/or color of the clothing. Then, the recommendation may be generated by taking into account the identification of clothing. For example, the product recommendation may include a recommendation for one or more beauty products that complement the identified clothing.

The method may also include presenting the at least one recommendation (step 208). The recommendation may be presented in a variety of ways. As used herein, the term “presenting” may involve sending information and/or computer readable instructions, for example via the same means used to obtain the personal information. The presenting could be performed by causing the recommendation to be displayed to the subject in a form perceptible by the user. The presenting may involve activity associated with transmitting information and/or instructions via a network so that the recommendation may be displayed to the subject via a display device viewed by the subject (e.g., a monitor associated with a computer used by the subject.) The presenting may alternatively involve directly displaying information on a display device viewed by the subject. FIG. 1 shows an example of a page that may be displayed as a result of the presenting of step 208. As shown, the page may recommend a beauty product for use on a specified day. In one example, the beauty product recommendation could recommend one or more beauty products that were previously caused to be sent to the subject. For example, such products may be beauty products previously sent to the subject for purposes of having the subject sample, test, or make a trial use of the products and/or the recommended products could be beauty products previously caused to be sent to the subject in response to the subject's purchase of the products.

In another example, the subject may be prompted for an identification of one or more beauty products available for the subject to use at the moment and the recommendation may include a recommendation to use of one of these beauty products.

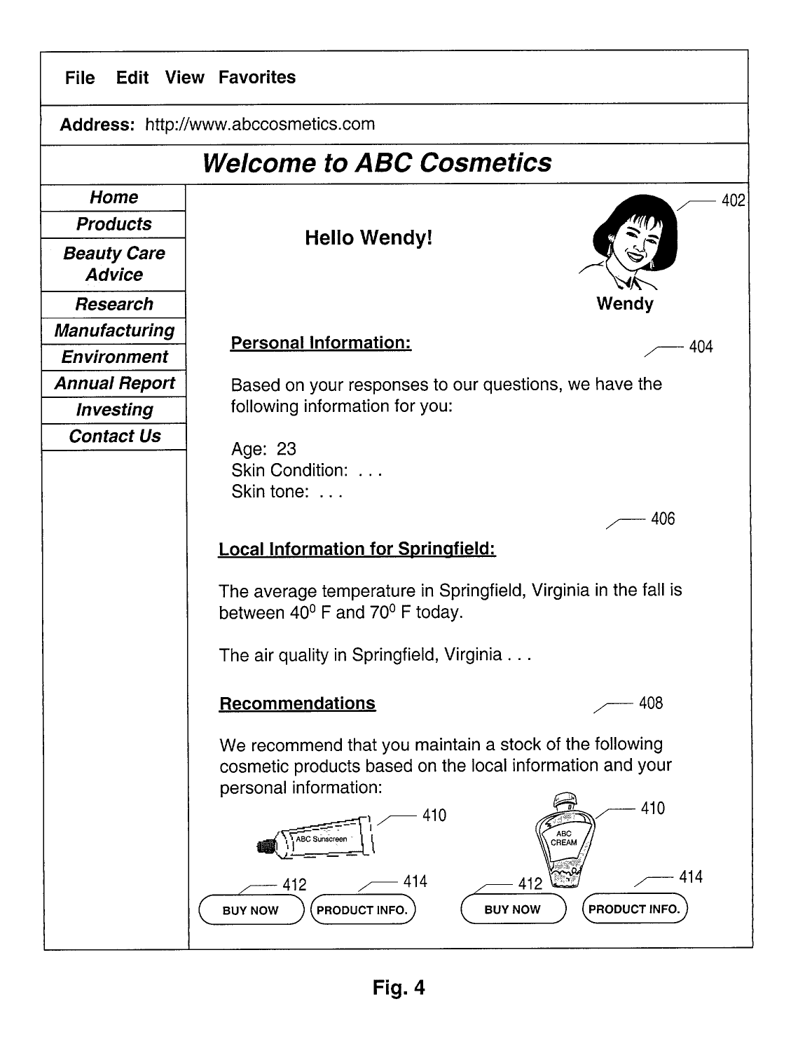

Optionally, a page similar to the page shown in FIG. 4 may be caused to be displayed to the subject. Such a page may include recommendations 408 including names and/or images 410 of beauty products and recommend that the subject purchase and/or maintain a stock of the displayed beauty products. As shown, the page may also include an image 402 of the subject, personal information 404 about the subject, and local information 406 for the geographic area of the subject. In addition, the page may include an option 412 that the subject may select to purchase the recommended beauty product(s) and/or an option 414 that the subject may select to obtain more information about the beauty product(s).

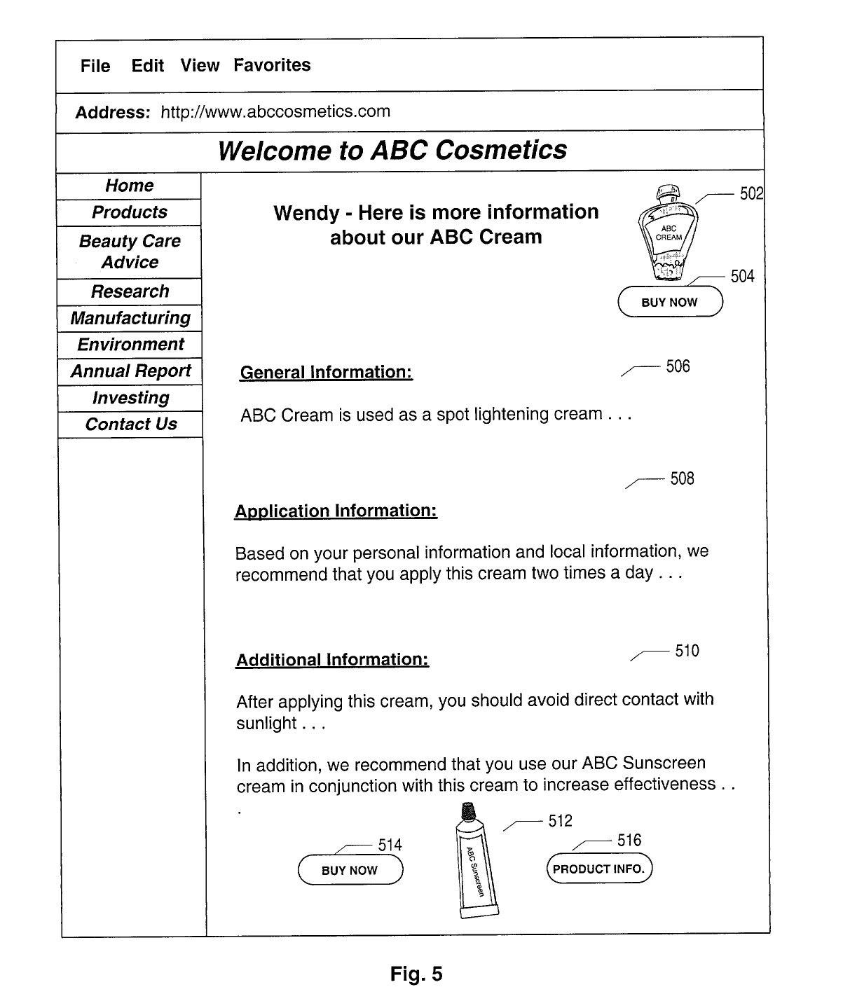

If a subject selects option 414 for one of the products displayed on the page, another page similar to the one shown in FIG. 5 may be caused to be displayed. As shown, the page may include the name and/or image 502 of the selected beauty product, an option 504 to purchase the product, general information 506 about the beauty product, product application information 508, and additional information 510. General information 506 may include general information about the selected product, such as intended uses and results of the product. Application information 508 may include information about how to apply the product. Additional information 510 may include other information about the product, such as side effects, precautions, and one or more other products that are recommended or not recommended to be used in conjunction with the selected beauty products. For example, as shown in FIG. 5, the page may include the name and/or image 512 of another beauty product that is recommended to be used in conjunction with the selected beauty product. In addition, the page may include options 514 and 516 which are similar to options 412 and 414, respectively.

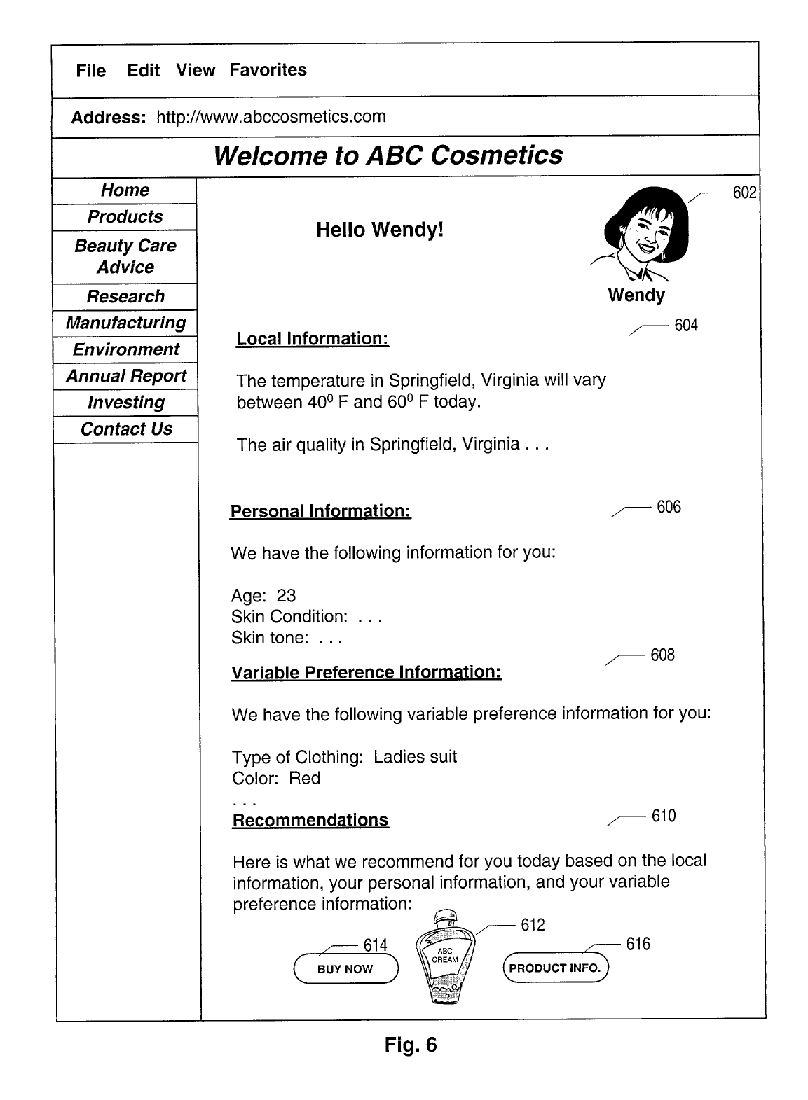

If the subject provides variable preference information, as discussed above, a page similar to the one shown in FIG. 6 may be caused to be displayed. The page may include an image 602 of the subject, local information 604, personal information 606 about the subject, variable preference information 608 about the subject, and recommendations 610. Recommendations 610 may include the name and/or image 612 of the recommended beauty products. The page may also include an option 614 and option 616, which are similar to options 412 and 414, respectively.

In accordance with the invention, the obtaining, determining, generating, and presenting steps of the method shown in FIG. 2 may be performed directly or indirectly. Examples of direct performance include maintaining a server that performs or facilitates the step. Examples of indirect performance include entering into a formal or informal relationship with a third party to have the third party perform the step. Another example of indirect performance includes hyperlinking so that users of a website may achieve benefits of the step by clicking through the hyperlinks.

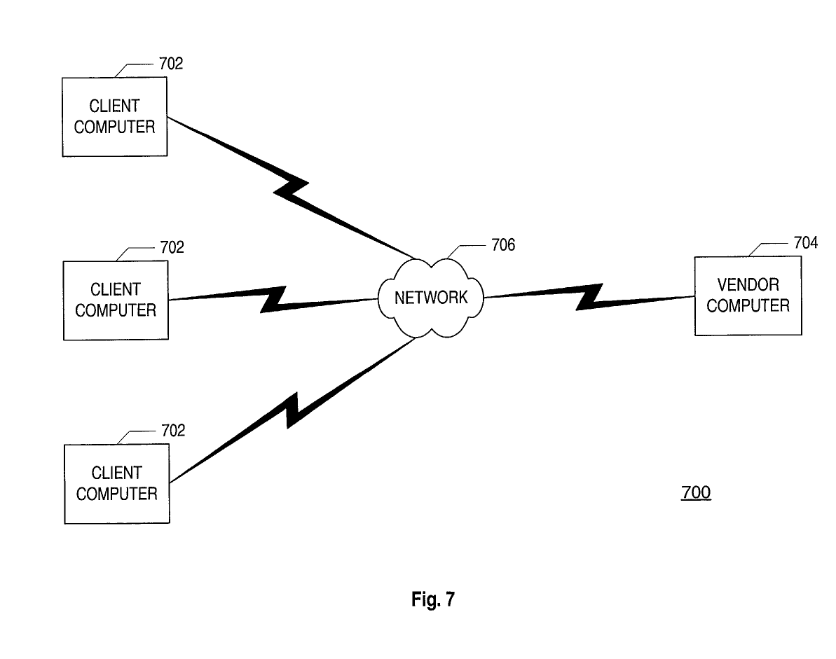

FIG. 7 is an exemplary block diagram of a system 700, in which the invention may be implemented. System 700 may include one or more client computers 702 and a vendor computer 704. Client computer 702 may interface with vendor computer 704 via a network 706. Network 706 may include a Local Area Network (LAN) or a Wide Area Network (WAN). In addition, network 706 may also include a combination of a public network, such as the Internet, and private networks. In a broader sense, network 706 may include any mechanism for facilitating communication between two nodes or remote locations.

Each client computer 702 may include a computer or any other processor capable of communicating with other computers. Client computer 702 may include a wired or a wireless device, including, but not limited to, a mobile computing device, a cellular phone, a specialized beauty advice dispensing unit, and a personal digital assistant (PDA).

Examples of specialized beauty advice dispensing unit may include a water-resistant device located in a bathroom of the subject's home. The device may automatically dispense beauty advice when a trigger occurs. The trigger may include the presence of the subject in the bathroom detected by sensors, the flipping of a light switch, audible or tactile command from the subject, flushing of a toilet, drawing of a bath/shower, or any other type of trigger. The device may dispense the beauty advice visually, audibly, or in any other manner.

Additionally, a user, such as the subject, may use client computer 702 to perform various tasks, including requesting beauty advice from vendor computer 704 and purchasing beauty products from vendor computer 704. Client computer 702 may run a browser, such as Internet Explorer or Netscape Navigator to assist the user in performing these tasks, and an image recording device, such as a camera to assist the user in capturing images. Client computer 702 may be located at a subject's home, a vendor's point of sale location, a salon, a spa, any other beauty facility, a free standing kiosk, and/or any other location where there may be a desire to obtain beauty advice.

Like client computer 702, vendor computer 704 may include a computer or any other processor capable of communicating with other computers. Vendor computer 704 may provide beauty advice and may receive and/or process requests to purchase beauty products. A vendor may include a manufacturer, distributor or reseller of beauty products, or any other entity involved in beautys product marketing, sales, services, or information distribution.

Other system and network configurations will be apparent to those of ordinary skill in the art and are also within the scope of the present invention. For example, system 700 as shown in FIG. 7 may include more than one vendor computer 704 to provide load balancing and fail-over capabilities. Likewise, it will be apparent to one of ordinary skill in the art that client computer 702 may perform the functions performed by vendor computer 704 and vice versa. For example, client computer 702 may include processes that perform the functions normally performed by software or processes running on vendor computer 704. Thus, a user may not need to connect to vendor computer 704 to retrieve and view analogous case histories and purchase cosmetic products. Moreover, it will be apparent to one of ordinary skill in the art that the computers shown in FIG. 7 may use various protocols, such as Hypertext Transport Protocol (HTTP) and Transmission Control Protocol/Internet Protocol (TCP/IP) to communicate with each other.

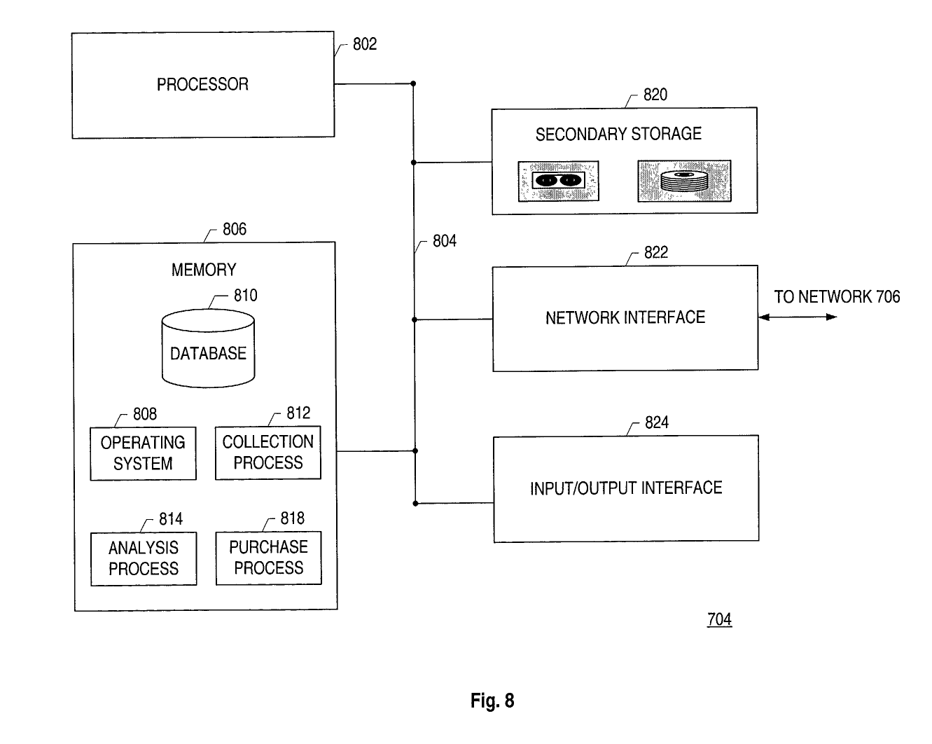

FIG. 8 is an exemplary block diagram of vendor computer 704, in accordance with methods and systems consistent with the present invention. Vendor computer 704 may include a processor 802, which connects via a bus 804 to a memory 806, a secondary storage 820, a network interface 822, and an input/output interface 824.

Memory 806 may include an operating system 808, a database 810, a collection process 812, an analysis process 814, and a purchase process 818. Memory 806 may also include a conventional web server process for hosting a website and a database management system.

Operating system 808 may include, for example, the Windows 2000 operating system available from Microsoft Corporation. Database 810 may include any type of database, such as a relational database. Database 810 may store a variety of information, including information about subjects and information about beauty products that are being offered for sale and/or recommended.

Collection process 812, analysis process 814, and purchase process 818 may include stored instructions in the form of software, which may be executed by processor 802. Collection process 812 may obtain and update information about subjects. Analysis process 814 may provide beauty advice. Purchase process 818 may include any conventional process that may assist a subject in purchasing products. For example, if network 706 includes the Internet, purchase process 818 may include a conventional shopping cart process.

Secondary storage 820 may comprise a computer readable medium, such as a disk drive, a tape drive and/or flash memory. From a tape drive, for example, software and data may be loaded onto the disk drive, which can then be copied into memory 806. Similarly, software and data in memory 806 may be copied onto the disk drive, which can then be loaded onto the tape drive. It is to be understood that the invention, in its broadest sense does not lie in the mechanisms or manner in which information is stored. Any mechanism or protocol is considered to be within the scope of the invention.

Network interface 822 may transmit messages from vendor computer 704 to other computers, such as client computers 702 and may receive messages addressed to vendor computer 704 from other computers, for example, via network 706. Input/Output interface 824 may include, for example, a key board, a key pad and/or a display unit. Any other tactile and/or voice activated mechanism may be used as an input device in accordance with the invention.

It will be apparent to one of ordinary skill in the art that a single process may perform the functions of collection process 812, analysis process 814, and/or purchase process 818.

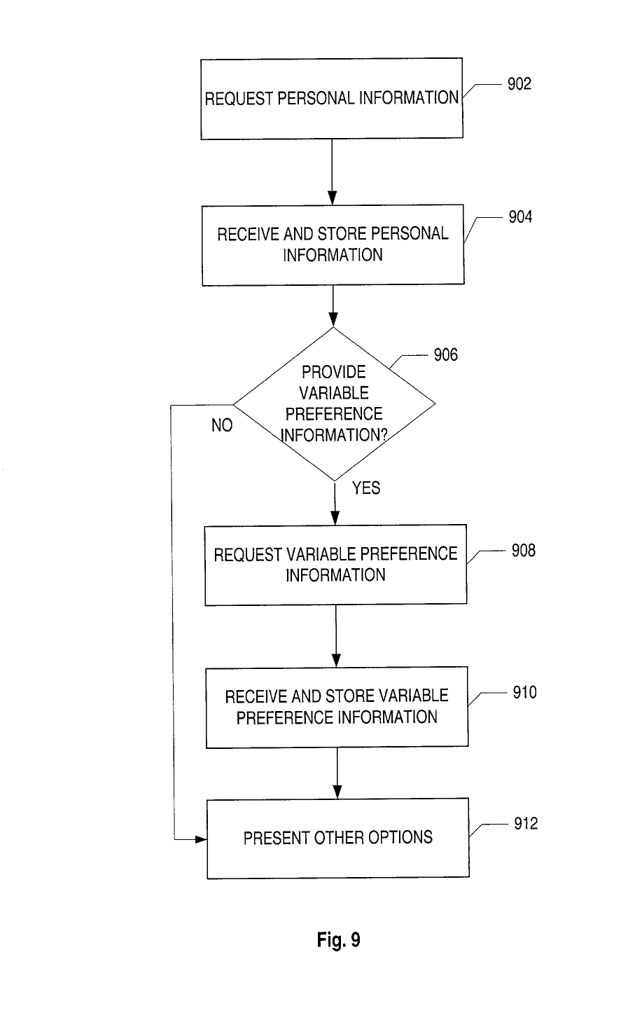

As discussed above, collection process 812 may obtain information about a subject. Collection process 812 may be invoked by the subject if collection process 812 is running on a client computer 702 or may be invoked by a vendor computer 704 in response to a subject's request for beauty advice. FIG. 9 is a flowchart illustrating exemplary steps that may be performed by collection process 812, in accordance with methods and systems consistent with the present invention.

Collection process 812 may request personal information from the subject (step 902). For example, collection process 812 may present a series of questions and/or prompts to the subject to encourage the subject to submit the personal information. The questions may be similar to the questions displayed in the questionnaire shown in FIG. 3. Collection process 812 may also prompt the subject for an image.

The subject may provide the requested information, for example, by answering the questions. The subject may also provide an image to collection process 812 if prompted by collection process 812. To capture the image, the subject may use an image recording device, such as a web cam connected to client computer 702. Alternatively, the image may be scanned from hard copy or otherwise obtained through any image capture mechanism.

After receiving the information and the image from the subject, collection process 812 may store the information and the image in database 810 (step 904), for example, by creating a record for the subject in the database. Next, collection process 812 may ask the subject if the subject would like to provide variable preference information (step 906). If the subject does not want to provide variable preference information, then collection process 812 may present the subject with other options (step 912), such as the opportunity to receive information about beauty products that the vendor sells.

On the other hand, if the subject does want to provide variable preference information, then collection process 812 may request the variable preference information from the subject (step 908). Again, this information may be requested by prompting the subject to answer a series of questions. Once the subject has provided the requested information, collection process 812 may receive and store the variable preference information in database 810 (step 910). After storing the information, collection process may present other options to the subject (step 912).

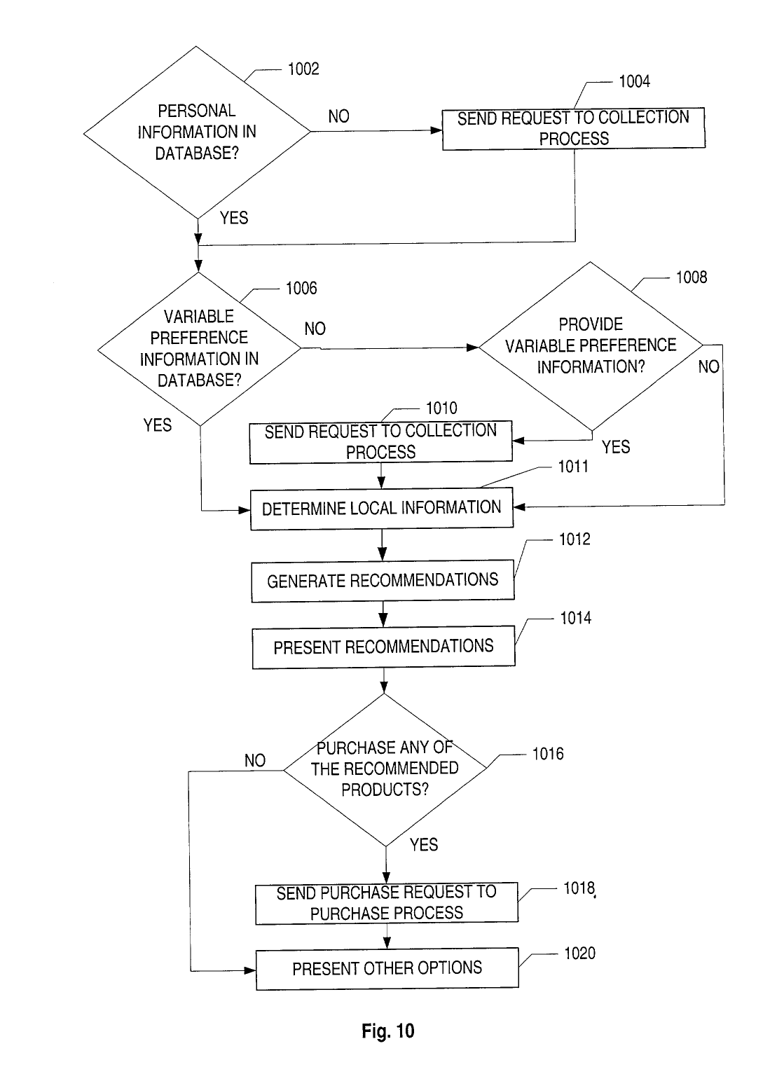

FIG. 10 is a flowchart illustrating exemplary steps that may be performed by analysis process 814, in accordance with methods and systems consistent with the present invention. Analysis process 814 may determine if database 810 includes personal information about the subject (step 1002), for example, by querying database 810. If the analysis process determines that database 810 does not have personal information about the subject, analysis process 814 may send a request to collection process 812 to obtain the personal information (step 1004). After collection process 812 has obtained and stored the information, collection process 812 may send a message to analysis process 814, which in turn may next determine if database 810 has variable preference information about the subject (step 1006)

On the other hand, if analysis process 814 determines that database 810 does have personal information about the subject (step 1002), analysis process 814 may next determine if database 810 has variable preference information about the subject (step 1006). If database 810 does not have the variable preference information, analysis process 814 may prompt the subject to determine if the subject would like to provide variable preference information (step 1008). If the subject does wish to provide the variable preference information, analysis process 814 may send a request to collection process 812 so that collection process 812 may obtain the variable preference information (step 1010). After collection process 812 has obtained and stored the variable preference information, collection process 812 may send a message to analysis process 814, which in turn may determine local information (step 1011).

If database 810 does include variable preference information, analysis process 814 may determine local information for the geographic area of the subject (step 1011). As discussed before, the local information may be obtained from another party, such as a weather forecasting service.

Although not shown in FIG. 10, analysis process 814 may allow the subject to update the subject's information before determining local information and/or allow the subject to choose which information is used to generate the recommendations.

After obtaining the local information, analysis process 814 may generate recommendations based on the personal information, variable preference information (if the subject provided this information), and local information (step 1012). As discussed before, a variety of methods may be used to generate the recommendations. For example artificial intelligence mechanisms may be used to generate the recommendations. In another example, there could be a retrieval of information from a database based on a data comparison.

Next, analysis process 814 may present the recommendations to the subject (step 1014). The recommendations may be presented in many ways. For example, a page such as the one shown in FIG. 4 may be caused to be displayed to the subject.

After presenting the recommendations, analysis process 814 may ask the subject if the subject would like to purchase any of the recommended products (step 1016). If the subject chooses to buy any of the recommended beauty products, analysis process 814 may send a signal to purchase process 818 (step 1018). The signal may include information about the beauty products that the subject wants to purchase. After sending the signal, analysis process 814 may allow the subject to perform other tasks by displaying other options, such as viewing information about other beauty products (step 1020). Purchase process 818 may in turn complete the purchase transaction using conventional methods and the product may be caused to be sent to the subject. On the other hand, if the subject does not want to purchase any products, the analysis process 814 may allow the subject to perform other tasks by displaying other options to the subject (step 1020).

It will be apparent to one of ordinary skill in the art that a subject may use analysis process 814 to seek beauty advice immediately prior to a time when the subject intends to apply a beauty product. For example, the time immediately prior to a time when the subject intends to apply a beauty product may include a night before or a day of intended beauty application.

It will also be apparent to one of ordinary skill in the art that various modifications may be made to the invention without departing from the scope of the invention. For example, instead of recommending products for purchase, analysis process 814 may prompt the subject to provide the analysis process 814 with a list of products that the subject previously received from a vendor and may recommend one of these products.

The above-noted features, other aspects, and principles of the present invention may be implemented in various system or network configurations. Such configurations and applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instruction or program code for performing various computer-implemented operations based on the methods and processes of the invention. The media and program instructions may be those specially designed and constructed for the purposes of the invention, or they may be of the kind well-known and available to those having ordinary skill in the computer software arts. The media may take many forms including, but not limited to, non-volatile media, volatile media, and transmission media. Non-volatile media includes, for example, optical or magnetic disks. Volatile media includes, for example, dynamic memory. Transmission media includes, for example, coaxial cables, copper wire, and fiber optics. Transmission media can also take the form of acoustic or light waves, such as those generated during radio-wave and infra-red data communications. Examples of program instructions include both machine code, such as produced by a compiler, and files containing a high level code that can be executed by the computer using an interpreter.

Another embodiment of the invention may include a method for providing beauty advice. The method may include maintaining a plurality of categories, obtaining information identifying a geographic area where beauty advice is to be dispensed, obtaining local information about the geographic area, generating a plurality of differing beauty product usage recommendations, and presenting the recommendations. Each category may be defined by at least one personal characteristic. A personal characteristic may include at least one of physical attributes, lifestyle preferences, fashion preference, color preferences, cosmetic preferences, nutritional preferences, medical history, dietary supplement usage, family history, and/or any other personal characteristic. The local information may include at least a weather forecast for the geographic area and/or the beauty product usage of individuals located in the geographic area. Each recommendation may be generated as a function of the local information and at least one of the plurality of categories.

For example, one category may be defined by a physical characteristic, such as dry skin. If local information for a geographic area indicates that there is or will be a local condition, such as low humidity, that may affect dry skin, then a recommendation may be generated to use a particular moisturizing cream. This recommendation may be presented to a beauty consultant, who may then dispense the recommendation to all of their clients having dry skin.

Since there are a plurality of categories, additional recommendations may be made for each category. Each recommendation may be organized by the category or combination of categories used to generate the information. The recommendations may be presented to subjects located or traveling in a geographic area. Or the recommendations may be presented to a third party (such as beauty consultants) for selective dispensation to others (such as clients of beauty consultants).

This application may discuss beauty products in connection with use by women. However, it is to be understood that such discussions are for exemplary purposes only. It is to be understood that the invention is equally applicable to all genders, and is not necessarily limited to the beauty industry. It is also to be understood that any functional aspect of the invention can be implemented via any location in the system or network, and data software may be resident at any location either in a network, at a stand-alone site, or on media in the custody and control of a user or subject.

It is to be further understood that the physical mechanisms (e.g. hardware, software, networks, systems) for implementing the methods of the invention are many. Networks, hardware and systems can be configured in a host of ways with software and hardware functionality residing at many alternative locations. In addition, systems other than the exemplary systems disclosed might be used to implement the invention. Therefore, it is to be understood that the methods of the invention are not limited to any particular structure.

Further, methods or portions thereof can be implemented in either an electronic environment, a physical environment, or combinations thereof. Thus, for example, although one or more portions of a method may occur in an electronic environment, a “purchase” portion of the method may occur in a brick and mortar store, or vice versa.

### Cross-reference to Concurrently Filed Applications and Global Definitions

This application claims priority on and incorporates by reference the following U.S. Provisional applications: Artificial Intelligence For Use In Cosmetic And Non-Cosmetic Environments, Application No. 60/325,561 (provisional filed Oct. 1, 2001); and Methods And Systems For Cosmetic And Non-Cosmetic Product Selection, Application No. 601325,559 (provisional filed Oct. 1, 2001).

The following concurrently filed U.S. patent applications are also incorporated herein by reference: Body Image Enhancement, Attorney Docket No. 05725.0972; Methods And Systems For Predicting And/Or Tracking Changes In External Body Conditions, Attorney Docket No. 05725.0973; Methods And Systems For Generating A Prognosis, Attorney Docket No. 05725.0974; Historical Beauty Record, Attorney Docket No. 05725.0975; Identification And Presentation Of Analogous Beauty Case Histories, Attorney Docket No. 05725.0976; Interactive Beauty Analysis, Attorney Docket No. 05725.0977; Feature Extraction In Beauty Analysis, Attorney Docket No. 05725.0978; Simulation Of An Aesthetic Feature On A Facial Image, Attorney Docket No. 05725.0979; Virtual Beauty Consultant, Attorney Docket No. 05725.0981; Calibrating Image Capturing, Attorney Docket No. 05725.0982; Use Of Artificial Intelligence In Providing Beauty Advice, Attorney Docket No. 0572.0983; Shop-In-Shop Website Construction, Attorney Docket No. 05725.0984; Early Detection Of Beauty Treatment Progress, Attorney Docket No. 05725.0985; Cosmetic Affinity Indexing, Attorney Docket No. 05725.0986; Systems And Methods For Providing Beauty Guidance, Attorney Docket No. 05725.0987; Methods and Systems Involving Simulated Application of Beauty Products, Attorney Docket No. 05725.1008; Customized Beauty Tracking Kit, Attorney Docket No. 05725.1009; Analysis Using Three-Dimensional Facial Image Attorney Docket No. 05725.1010; Body Image Templates With Pre-Applied Beauty Products, Attorney Docket No. 05725.1011; and Image Capture Method, Attorney Docket No. 05725.1012.

To the extent not inconsistent with the invention defined herein, definitions and terminology usage in the above-mentioned concurrently filed applications, the above-mentioned priority applications, and the following global definitions are to be considered in interpreting the language of this patent and the claims herein. Where multiple definitions are provided, they should be considered as a single cumulative definition.

The term “image” may include one or more of two-dimensional and three-dimensional representations. In certain examples consistent with the invention, a plurality of images from different perspectives may be used to construct a three-dimensional image. In a broader sense, only a single image may be used. Depending on the embodiment, the term “image” may include either a visually perceptible image or electronic image data that may be either used to construct a visually perceptible image or to derive information about the subject. The image may be a body image corresponding to an anatomical portion of the subject, and may represent, for example, the subject's entire face, or a portion of the subject's face. The image may be a detailed picture (e.g., a digital image or a photograph) of a portion of the subject's body and/or a topological plot mapping contours of a portion of subject's body. If the image is representative of an external body condition, the image could be either an actual image showing the condition or an image including symbolizations of the condition, for example. The image may be an actual or a simulated image. Simulated images may include wholly or partially generated computer images, images based on existing images, and images based on stored features of a subject.

The term “image capture device”, similar terms, and terms representing structures with similar functions may include one or more of a digital camera, webcam, film camera, analog camera, digital video camera, scanner, facsimile machine, copy machine, infrared imager, ultra-sound imaging device, or any other mechanism for acquiring an image of a subject's external body condition, an image of the subject's countenance, an/or an image of the subject's skin. An ultrasonic device might provide skin thickness information, or it might create a map on an area of the external location. Thus, the term “image” as used herein may be broader than a picture. Combinations of image capture devices may be used. For example, an image captured on photographic paper using a film camera might then be scanned on a flat bed scanner to create another image.

The term “capturing (an image)”, or any form thereof, refers to the use of an image capture device to acquire an image. “Capturing” may refer to the direct act of using the image capture device to acquire the image. It may also include indirect acts to promote acquisition. To this end, “capturing” may include the indirect acts of providing access to hardware, or to at least one of a client-based algorithm and a server-based algorithm for causing the image capture device to capture an image. This may be accomplished by providing a user with software to aid in the image capture process, or providing the user with access to a network location at which the software resides. Also consistent with certain embodiments of the invention, capturing may include at least one of receiving an instruction from the subject to capture an image, indicating to the subject before the image is captured, and indicating to the subject when the image is captured.

The term “image processing technique” or similar terms, may include a software program, computer, application specific integrated circuit, electronic device and/or a processor designed to identify in an image one or more characteristics, such as a skin condition. Such techniques may involve binarization, image partitioning, Fourier transforms, fast Fourier transforms (FFTs), and/or discrete cosine transforms may be performed on all or part of the image, resulting in coefficients. Based on the coefficients, conditions may be located, as known in the art. Artificial intelligence, such as fuzzy logic, neural networks, genetic programming and decision tree programming, may also be used to identify conditions. Alternatively, one or more digital filters may be passed through the image for locating specific conditions. These examples are provided for illustrative purposes with the understanding that any image processing technique may be used.

The term “network interface” or similar terms, refer to any mechanism for aiding communications between various nodes or locations in a network. A network interface may include, for example a bus, a modem, or any other input/output structure. A network interface may permit a connection to any network capable of being connected to an input and/or output module located within at least one or more of the following exemplary networks: an Ethernet network, an Internet Protocol network, a telephone network, a radio network, a cellular network, or any mechanism for permitting communication between two or more modes or remote locations. In some invention embodiments, a network interface might also included a user interface.

The term “user interface” may include at least one component such as a keyboard, key pad, mouse, track ball, telephone, scanner, microphone, touch screen, web cam, interactive voice response system (IVR), voice recognition system or any other suitable input mechanism for conveying information. A user interface may also include an input port connected by a wired, optical, or wireless connection for electromagnetic transmissions. In some embodiments, a user interface may include connections to other computer systems to receive the input commands and data therefrom. User interface may further include a data reading device such as a disk drive for receiving input data from and writing data to storage media such as magnetic and optical disks.

As used herein terms such as “external body condition”, “skin condition”, and “actual condition” refer to conditions of at least one of the skin, teeth, hair, eyebrows, eyelashes, body hair, facial hair, fingernails, and/or toenails, or any other externality. Examples of skin conditions may include elasticity, dryness, cellulitis, sweating, aging, wrinkles, melanoma, exfoliation, desquamation, homogeneity of color, creases, liver spots, clarity, lines, micro-circulation, shininess, softness, smoothness, tone, texture, matitty, hydration, sag, suppleness, stress, springiness, firmness, sebum production, cleanliness, translucency, luminosity, irritation, redness, vasocolation, vasomotion, vasodilation, vasoconstriction, pigmentation, freckles, blemishes, oiliness, pore distribution, pore size, moles, birthmarks, acne, blackheads, whiteheads, pockmarks, warts, pustules, boils, blisters, marks, smudges, specks, psoriasis and other characteristics associated with the subject's skin. Examples of hair conditions may include keratin plug, length, dryness, oiliness, dandruff, pigmentation, thickness, density, root conditions, split ends, hair loss, hair thinning, scales, staging, cleanliness and other properties related to the subject's hair. Examples of fingernail and toenail conditions may include onychomycosis, split nails, delaminating, psoriasis, brilliancy, lines, spots, coloration, gloss, strength, brittleness, thickness, hangnail, length, disease, and other characteristics related to the subject's nails. Other conditions may include, for example, size and proportion of facial features, teeth discoloration, and any other aesthetic-related or physical, physiological, or biological conditions of the user.

“Enabling”, “facilitating”, and “causing” an action refer to one or more of a direct act of performing the action, and any indirect act of encouraging or being an accessory to the action. Thus, the terms include partnering or cooperating with an entity who performs the action and/or referring commerce to or having commerce referred from an entity who performs the action. Other examples of indirect activity encompassed within the definitions of “enabling”, “facilitating”, and “causing” may include providing a subject with one or more of tools to knowingly aid in performing the action, providing instructions on how to perform the action, providing prompts or cues to perform the action, or expressly encouraging performance of the action. Indirect activity may also include cooperating with an entity who either directly performs the action or who helps another perform the action. Tools may include software, hardware, or access (either directly, through hyperlink, or some other type of cooperation or partnering) to a network location (e.g., web site) providing tools to aid in performing the action. Thus, phrases such as “enabling access” and “enabling display” do not necessary require that the actor actually access or display anything. For example, the actor may perform the enabling function by affiliating with an entity who performs the action, or by providing instructions, tools, or encouragement for another to do the accessing and displaying.

Forms of the word “displaying” and like terms may also include indirect acts such as providing content for transmission over a network to a display device, regardless of whether the display device is in the custody or control of the sender. Any entity in a chain of delivering information for display performs an act of “displaying”, as the term is used herein.

Likewise, the term “providing” includes direct and indirect activities. For example, providing access to a computer program may include at least one of providing access over a network to the computer program, and creating or distributing to the subject a computer program configured to run on the subject's workstation or computer. For example, a first party may direct network traffic to (either through electronic links or through encouragement to visit) a server or web site run by a second party. If the second party maintains a particular piece of software thereon, then it is to be understood that within the meaning of “providing access” as used herein, the first party is said to provide access to the particular software. Or if the first party directs a subject to a second party who in turn ships the particular software to the user, the first party is said to provide the user with access to the particular software. (Of course, in both of the above instances, the second party would also be providing access within the meaning of the phrase as used herein.) “Receiving” may include at least one of acquisition via a network, via verbally communication, via electronic transmission, via telephone transmission, in hard-copy form, or through any other mechanism enabling reception. In addition, “receiving” may occur either directly or indirectly. For example, receipt may occur through a third party acting on another party's behalf, as an agent of another, or in concert with another. Regardless, all such indirect and direct actions are intended to be covered by the term “receiving” as used herein. A received request, for example, may take one of many forms. It may simply be a checked box, clicked button, submitted form or oral affirmation. Or it might be a typed or handwritten textual request. Receiving may occur through an on-line interest form, e-mail, facsimile, telephone, interactive voice response system, or file transfer protocol transmitted electronically over a network at a web site, an internet protocol address, or a network account. A request may be received from a subject for whom information is sought, or an entity acting on the subject's behalf. “Receiving” may involve receipt directly or indirectly through one or more networks and/or storage mediums. Receipt may occur physically such as in hard copy form, via mail delivery or other courier delivery.

Forms of the word “maintain” are used broadly to include gathering, storing, accessing, providing access to, or making something available for access, either directly or indirectly. For example, those who maintain information include entities who provide a link to a site of a third party where the information is stored.

Consistent with the concepts set forth above, all other recited actions such as, for example, obtaining, determining, generating, selecting, applying, simulating, presenting, etc., are inclusive of direct and indirect actions. Thus, for purposes of interpreting the following claims, an entity performs a recited action through either direct or indirect activity. Further examples of indirect activity include sending signals, providing software, providing instructions, cooperating with an entity to have the entity perform the action, outsourcing direct or indirect actions, or serving in any way as an accessory to the specified action.

The term “product” is used to generically refer to tangible merchandise, goods, services, and actions performed. A “beauty product,” “beauty care product,” “cosmetic product” or similar terms, refer to products (as defined above) for effecting one or more external body conditions, such as conditions of the skin, hair and nails. Examples of tangible merchandise forms of beauty products include cosmetic goods, such as treatment products, personal cleansing products, and makeup products, in any form (e.g., ointments, creams, gels, sprays, supplement, ingesta, inhalants, lotions, cakes, liquids, and powders.)

Examples of services forms of beauty products include hair styling, hair cutting, hair coloring, hair removal, skin treatment, make-up application, and any other offering for aesthetic enhancement. Examples of other actions performed include massages, facial rubs, deep cleansings, applications of beauty product, exercise, therapy, or any other action effecting the external body condition whether performed by a professional, the subject, or an acquaintance of the subject.

The following is exemplary and non-exhaustive listing of a few beauty products- scrubs, rinses, washes, moisturizers, wrinkle removers, exfoliates, toners, cleansers, conditioners, shampoos, cuticle creams, oils, and anti-fungal substances, anti-aging products, anti-wrinkle products, anti-freckle products, skin conditioners, skin toners, skin coloring agents, tanners, bronzers, skin lighteners, hair coloring, hair cleansing, hair styling, elasticity enhancing products, agents, blushes, mascaras, eyeliners, lip liners, lipsticks, lip glosses, eyebrow liners, eye shadows, nail polishes, foundations, concealers, dental whitening products, cellulite reduction products, hair straighteners and curlers, and weight reduction products. A beauty care treatment regimen may involve the administration of one or more products, as defined above.

The terms “beauty advice”, “beauty guidance”, and similar terms are used interchangeably to refer to the provision of beauty related information to a subject. Advice or guidance includes one or more of beauty product recommendations (e.g., cosmetic product recommendations for products to treat conditions the subject is prompted to evaluate), remedial measures, preventative measures, predictions, prognoses, price and availability information, application and use information, suggestions for complementary products, lifestyle or dietary recommendations, or any other information intended to aid a subject in a course of future conduct, to aid a subject in understanding past occurrences, to reflect information about some future occurrences related to the subject's beauty or to aid a subject in understanding beauty products, as defined above.

The term “network” may include a public network such as the Internet or a telephony network, a private network, a virtual private network, or any other mechanism for enabling communication between two or more nodes or locations. The network may include one or more of wired and wireless connections. Wireless communications may include radio transmission via the airwaves, however, those of ordinary skill in the art will appreciate that various other communication techniques can be used to provide wireless transmission including infrared line of sight, cellular, microwave, satellite, blue-tooth packet radio and spread spectrum radio. Wireless data may include, but is not limited to, paging, text messaging, e-mail, Internet access and other specialized data applications specifically excluding or including voice transmission.

In some instances consistent with the invention, a network may include a courier network (e.g. postal service, United Parcel Service, Federal Express, etc.). Other types of networks that are to be considered within the scope of the invention include local area networks, metropolitan area networks, wide area networks, ad hoc networks, or any mechanism for facilitating communication between two nodes or remote locations.

“Artificial intelligence” (AI) is used herein to broadly describe any computationally intelligent systems that combine knowledge, techniques, and methodologies. An AI engine may be any system configured to apply knowledge and that can adapt itself and learn to do better in changing environments. Thus, the AI engine may employ any one or combination of the following computational techniques: neural network, constraint program, fuzzy logic, classification, conventional artificial intelligence, symbolic manipulation, fuzzy set theory, evolutionary computation, cybernetics, data mining, approximate reasoning, derivative-free optimization, decision trees, or soft computing. Employing any computationally intelligent techniques, the AI engine may learn to adapt to unknown or changing environment for better performance. AI engines may be implemented or provided with a wide variety of components or systems, including one or more of the following: central processing units, co-processors, memories, registers, or other data processing devices and subsystems.

AI engines may be trained based on input such as product information, expert advice, user profile, or data based on sensory perceptions. Using input an AI engine may implement an iterative training process. Training may be based on a wide variety of learning rules or training algorithms. For example, the learning rules may include one or more of the following: back-propagation, real-time recurrent learning, pattern-by-pattern learning, supervised learning, interpolation, weighted sum, reinforced learning, temporal difference learning, unsupervised learning, or recording learning. As a result of the training, AI engine may learn to modify its behavior in response to its environment, and obtain knowledge. Knowledge may represent any information upon which AI engine may determine an appropriate response to new data or situations. Knowledge may represent, for example, relationship information between two or more products. Knowledge may be stored in any form at any convenient location, such as a database.

Since AI engine may learn to modify its behavior, information describing relationships for a universe of all combinations of products may not need to be maintained by the AI engine or any other component of the system.

“Personal information”, “subject specific information”, “user specific information”, “user profile”, “personal characteristics”, “personal attributes”, “profile information”, and like terms (collectively referred to in this section as “personal information”) may broadly encompass any information about the subject or user. Such information may, for example, fall within categories such as physical characteristics, fashion preferences, demographics, nutritional information, cosmetic usage information, medical history information, environmental information, beauty product usage information, lifestyle, and may include information such as name; age; birth date; height; weight; ethnicity; eating habits; vacation patterns; geographic location of the individual's residence, location, or work; work habits; sleep habits; toiletries used; exercise habits; relaxation habits; beauty care habits; smoking and drinking habits; sun exposure habits; use of sunscreen; propensity to tan; number of sunburns and serious sunburns; dietary restrictions; dietary supplements or vitamins used; diagnosed conditions affecting the external body, such as melanoma; an image, such as a picture or a multimedia file of the subject; facial feature characteristics; family history information such as physical characteristics information about relatives of the subject (e.g., premature balding, graying, wrinkles, etc.); external body condition (as defined previously); color preferences, clothing style preferences, travel habits; entertainment preferences; fitness information; adverse reactions to products, compounds, or elements (e.g., sun exposure); body chemistry, use of prior beauty care products and their effectiveness; purchasing, shopping, and browsing habits; hobbies; marital status; whether the subject is a parent; country of residence; region of residence; birth country and region; religious affiliation; political affiliation; whether the subject is an urban dweller suburban dweller or rural area dweller; size of urban area in which the subject lives; whether the subject is retired; annual income, sexual preference, or any other information reflecting habits, preferences, or affiliations of the subject.

Personal information may also include information electronically gleaned by tracking the subject's electronic browsing or purchasing habits, or as the result of cookies maintained on the subject's computer, responses to surveys, or any other mechanism providing information related to the subject. In addition, personal information may be gathered through non-electronic mechanisms such as hard copy surveys, personal interviews, or consumer preference polls.

“Complementary” and “complementary product” refers to one or more of physical, physiological, biologically, and aesthetic compatibility. A product may be complementary with one or more of another product, a group of products, or a subject. In that latter instance, whether a product is considered “complementary” may be a function of personal information of the subject. Thus, for example a product may be complementary if it is unlikely to cause an adverse allergic reaction; if it physically blends well with another product; or if it is aesthetically consistent with the subject or one or more other products. Aesthetic compatibly may refer to the fact that two products are aesthetically appealing (or do not clash) when worn together. The identification of a complementary product may also be based on product characteristics, user preferences, survey data, or expert advice.

As used herein, the words “may” and “may be” are to be interpreted in an open-ended, non-restrictive manner. At minimum, “may” and “may be” are to be interpreted as definitively including structure or acts recited. Further, the word “or” is to be interpreted in the conjunctive and the disjunctive.

While flow charts presented herein illustrate a series of sequential blocks for exemplary purposes, the order of blocks is not critical to the invention in its broadest sense. Further, blocks may be omitted and others added without departing from the spirit of the invention. Also, the invention may include combinations of features described in connection with differing embodiments.

Although a focus of the disclosure may be on server-side methods, it is nevertheless to be understood that the invention includes corresponding client-side methods, software, articles of manufacture, and computer readable media, and that computer readable media can be used to store instructions for some or all of the methods described herein. Further, it is to be understood that disclosed structures define means for implementing the functionality described herein, and that the invention includes such means for performing the disclosed functions.

In the foregoing Description of Exemplary Embodiments, various features are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Exemplary Embodiments, with each claim standing on its own as a separate embodiment of the invention.

What is claimed is:

1. A method for providing beauty advice, the method comprising:
obtaining personal information about a subject, the personal information including at least demographic information about the subject, the demographic information reflecting a geographic area location of the subject;
determining local information based on the demographic information;
generating at least one recommendation for use of at least one cosmetic product based on at least one of the personal information and the local information; and
presenting the at least one recommendation.

2. The method of claim 1, wherein the local information includes a weather forecast.

3. The method of claim 1, wherein the local information includes data on cosmetic usage of others located in the geographic area of the subject.

4. The method of claim 1, wherein the local information includes air quality data for the geographic area of the subject.

5. The method of claim 1, wherein the local information includes climate data for the geographic area of the subject.

6. The method of claim 1, wherein the local information includes ecological data for the geographic area of the subject.

7. The method of claim 1, wherein the personal information further includes at least one of an image, physical characteristics information, lifestyle information, environmental information, nutritional information, medical history information, dietary supplement usage information, and family history information.

8. The method of claim 7, wherein the lifestyle information includes at least one of fashion preferences, clothing color preferences, and cosmetic preferences.

9. The method of claim 7, wherein the physical characteristics information includes at least one of age, a skin condition, skin tone, a propensity to tan, hair color, and facial feature characteristics.

10. The method of claim 7, wherein the family history information includes historical physical characteristics information about relatives of the subject.

11. The method of claim 1, wherein the recommendation is based on a combination of physical characteristics information about the subject, climate data for the geographic area of the subject, and at least one of fashion and color preferences of the subject.

12. The method of claim 1, further comprising receiving over a network, at a site remote from the subject, the personal information about the subject, and transmitting the recommendation to the subject over the network.

13. The method of claim 1, further comprising receiving variable preference information from the subject, and wherein the generated recommendation is a function of physical characteristics information, the local information, and the variable preference information.

14. The method of claim 13, wherein the variable preference information includes an identification of clothing that the subject intends to wear, and wherein the recommendation contains a suggestion to use at least one product complementary to the identified clothing.

15. The method of claim 14, wherein the identification of clothing is a color of clothing that the subject intends to wear.

16. The method of claim 14, wherein the product is a cosmetic product for adding color to a face of the subject.

17. The method of claim 1, implemented over a network having an subject-accessible node, and wherein the method further comprises prompting the subject to seek cosmetic advice by accessing the node immediately prior to a time when the subject intends to apply a cosmetic product.

18. The method of claim 17, wherein the time immediately prior is one of an evening before or a day of intended cosmetic application.

19. The method of claim 1, further including notifying the subject of a plurality of cosmetic products from which the recommendations will be generated, and suggesting that the subject maintain a stock of the plurality of cosmetic products.

20. The method of claim 1, further comprising receiving from the subject an identification of products at the subject's immediate disposal.

21. The method of claim 7, wherein the physical characteristics information includes at least one of color, tone, texture, elasticity, oiliness, and pH of at least one of the subject's hair and skin.

22. The method of claim 1, further comprising receiving a request from the subject for beauty advice.

23. The method of claim 22, wherein the at least one recommendation is generated in response to the request.

24. The method of claim 1, wherein the recommendation is based on both the personal information and the local information.

25. A method for providing beauty advice to a subject, the method comprising:
obtaining personal information about the subject, the personal information including at least demographic information about the subject, the demographic information reflecting a geographic area location of the subject;
generating a list of a plurality of cosmetic products for the subject;
receiving from the subject a request for cosmetic advice;
accessing local information for the geographic area; and
generating at least one recommendation for use of at least one cosmetic product on the list, the at least one recommendation being a function of the personal information of the subject and the local information.

26. The method of claim 25, conducted at least in part in a network environment, wherein receiving the request occurs via a network and in at least one location remote from a location of the subject.

27. A system for providing beauty advice, the system comprising:
memory for storing personal information about a subject, the personal information including at least demographic information about the subject, the demographic information including a geographic area location of the subject; and
a processor for accessing local information for the geographic area and for generating at least one recommendation for use of at least one cosmetic product, the at least one recommendation being a function of the personal information of the subject and the local information.

28. The system of claim 27, wherein the processor is also configured to generate at least one suggestion for clothing based on at least the local information.

29. The system of claim 27, wherein the at least one cosmetic product is chosen from makeup and hair products.

30. A system for providing beauty advice, the system comprising:
a memory including a program that
obtains personal information about a subject, the personal information including at least demographic information about the subject, the demographic information reflecting a geographic area location of the subject,
determines local information based on the demographic information,
generates at least one recommendation for use of at least one cosmetic product based on at least one of the personal information and the local information, and
presents the at least one recommendation; and
a processor that runs the program.

31. A computer-readable medium containing instructions for causing a computer to perform a method for providing beauty advice, the method comprising:
obtaining personal information about a subject, the personal information including at least demographic information about the subject, the demographic information reflecting a geographic area location of the subject;
determining local information based on the demographic information;
generating at least one recommendation for use of at least one cosmetic product based on at least one of the personal information and the local information; and
presenting the at least one recommendation.

32. A method for providing beauty advice, the method comprising:
maintaining a plurality of categories, each category being defined by at least one personal characteristic;
obtaining information identifying a geographic area where beauty advice is to be dispensed;
obtaining local information about the geographic area, the local information at least including a weather forecast for the geographic area;
generating a plurality of differing cosmetic product usage recommendations, each recommendation being a function of the local information and at least one of the plurality of categories; and
presenting the recommendations.

33. The method of claim 32, wherein presenting includes presenting the recommendations to a beauty consultant.

34. The method of claim 32, wherein presenting includes organizing recommendations by category.

35. The method of claim 32, wherein the local information includes data on cosmetic usage of a plurality of individuals located in the geographic area.

36. The method of claim 32, wherein the at least one personal characteristic includes at least one of physical attributes, lifestyle preferences, fashion preferences, color preferences, cosmetic product preferences, nutritional preferences, medical history, dietary supplement usage, and family history.

37. The method of claim 36, wherein the physical attributes include at least one of age, skin condition, skin tone, propensity to tan, hair color, and facial feature characteristics.

38. The method of claim 32, wherein the local information includes at least one of air quality data, temperature data, precipitation data, humidity data, wind data, ultra-violet radiation data, ecological data, and other climate information.

39. The method of claim 32, further comprising receiving variable preference information about a subject to receive beauty advice, and wherein the at least one generated recommendation is a function of physical characteristics information, the local condition information, and the variable preference information.

40. The method of claim 32 conducted at least in part in a network environment, wherein obtaining information identifying the geographic area and obtaining the local information occur via a network and in at least one location remote from the geographic area, and wherein presenting the recommendations occurs via the network.

41. A method for providing beauty advice, the method comprising:
obtaining information about a geographic area;
generating at least one recommendation for use of at least one cosmetic product based on the information; and
providing at least one entity in the geographic area with the recommendation.

42. The method of claim 41 conducted at least in part in a network environment, wherein obtaining information occurs via a network and in at least one location remote from the entity, and wherein during providing, the recommendations are provided to the entity over the network.

43. A method for providing beauty advice, the method comprising:
obtaining personal information about a subject, the personal information including at least demographic information about the subject, the demographic information reflecting a geographic area location of the subject;
determining local information based on the demographic information;
generating at least one cosmetic analysis based on at least one of the personal information and the local information; and
presenting the at least one cosmetic analysis.

44. The method of claim 43, wherein the cosmetic analysis includes at least one of a recommendation for use of a cosmetic product, a recommendation for a diagnosis to be performed on the subject, a recommendation to follow a beauty treatment regimen, and a prognosis for an external body condition of the subject.

45. The method of claim 43 conducted, at least in part in a network environment, wherein obtaining personal information occurs via a network and in at least one location remote from a location of the subject, and wherein during presenting, the at least one cosmetic analysis is presented to the subject via the network.

46. The method of claim 43, wherein the local information reflects at least one of a local weather condition, a local air quality condition, and a local ultraviolet level.

47. The method of claim 43, wherein the at least one cosmetic analysis is based on both the personal information and the local information.
